(19) United States
(12) Patent Application Publication
(10) Pub. No.: US 2005/0201589 A1
(43) Pub. Date: Sep. 15, 2005

(54) Thin speaker and method of manufacturing the speaker

(75) Inventors: Hiroshi Sugata, Tokyo (JP); Hirohumi Onohara, Tokyo (JP)

Correspondence Address: John H Lynn, Suite C 103, 2915 Redhill Avenue, Costa Mesa, CA, 92626, US

(73) Assignee: Foster Electric Co., Ltd., Tokyo (JP)

(21) Appl. No.: 10/505,344

(22) PCT Filed: Feb. 24, 2003
(86) PCT No.: PCT/JP03/01988

§ 371 Date: Aug. 19, 2004

(30) Foreign Application Priority Data
Feb. 25, 2002 (JP) 2002-047339

(51) Int. Cl. H04R 25/00

(52) U.S. Cl. 381/433; 381/395

(57) ABSTRACT

A thin speaker having a magnetic circuit (2) disposed at the front of a cone-like diaphragm, wherein an internal magnetic type magnetic circuit (2) and a vibration system are supported by a sufficiently strong frame formed of two pieces having an outline of generally disk-shape and partly overlapped concentrically with each other, the acoustic characteristics are prevented from being deteriorated by preventing support bodies (7, 7A) for the magnetic circuit (2) from covering the forward of the sound emitting face of the cone-like diaphragm (3), and speaker component parts are formed so as to be assembled by stacking on one jig (1) from one direction with a specified procedure, whereby an assemblability can be improved.

### TECHNICAL FIELD

This invention relates to thin speakers in which the thinning of a speaker as a whole is attempted by disposing its magnetic circuit on the front side of a cone-shaped diaphragm, and to a method of manufacturing such speakers.

### BACKGROUND ART

In the speakers, such as in-vehicle speakers, which are employed under conditions of limited spaces for disposition, thinning the speakers is necessarily required for responding to the requirement for space reduction.

For the response thereto, there have been suggested various measures for rendering the speakers thinner in their entire dimensions with an inner-magnet type magnetic circuit disposed in a space in front of the cone-shaped diaphragm, so that any parts of the magnetic circuit will not project rearward of the speaker.

As an example of prior art references attempting the thinning of speakers, there has been, for example, a Japanese Patent No. 2,685,175. FIG. 7 shows a sectioned view of the speaker disclosed therein.

In this speaker, the thinning of the speaker is accomplished by placing a magnetic circuit 20, diaphragm 21 and so on between a basket 22 disposed on the front side and a basket 23 disposed on the rear side, the baskets thus being in a paired front-and-rear arrangement in which the magnetic circuit 20 is supported by the front basket 22 and a vibration system is supported by the rear basket 23, and by enclosing the vibration system comprising the magnetic circuit 20, diaphragm 21, and so on, between these front and rear baskets 22 and 23.

However, in this prior art, there has been a problem that, because the magnetic circuit 20 is supported by the front basket 22 and the cone-shaped diaphragm 21 is provided on the rear side thereof, the front side of the sound radiating surface of the cone-shaped diaphragm 21 is covered by the front basket 22, which gives a bad influence on the acoustic characteristics.

As examples of the prior art references which have solved this problem, there are Japanese Utility Model Registration Nos. 2,579,525 and 3,001,527. FIG. 8 shows the speaker of the former, and FIG. 9 shows the speaker of the latter.

In these speakers, there is adopted a configuration in which the magnetic circuit 30 is supported by a supporting body 31 on the rear side of the diaphragm.

Consequently, there exists no hindrance against the sound on the front side of the sound radiating surface of the diaphragm 32, resulting in preventing damaging or degrading the acoustic characteristics.

However, in any of the above-described configurations, because there is no application of an ordinary assembling method in which the inner circumferential surface of the voice coil 33 is controlled by means of a gap gauge to position and mount the voice coil 33 in the magnetic gap, there is a problem that the assembling in high precision cannot be attained and such troubles as rubbing action of the voice coil and so on is apt to occur.

Further, there is some disadvantage in the aspect of the strength because of the unitary structure of the frame.

The present invention has been suggested in order to solve the foregoing problems, and its object is to provide a thin speaker and a method of manufacturing the speaker, wherein the thin speaker having an inner-magnetic type magnetic circuit disposed on the front side of a cone-shaped diaphragm can be obtained without provoking any degradation of the acoustic characteristics, and highly-precise assembling can be realized through simpler steps without causing any rubbing of the voice coil and so on, but with sufficient strength obtained.

### DISCLOSURE OF INVENTION

In order to solve the above problems, the thin speaker of the present invention is characterized in that a frame is made to be of a two-piece structure with an upper frame 5 and a bottom frame 8 disposed behind thereof concentrically and joined with their part overlapping, wherein the upper frame 5 is supporting a vibration system including a cone-shaped diaphragm 3 having an edge 4 at an outer periphery, a voice coil 6 coupled to a neck part of the diaphragm 3, a damper 9 supporting the voice coil 6 and so on, a central part of the bottom frame 8 is supporting a supporting member 7, 7A for a magnetic circuit 2 in a magnetic gap of which the voice coil 6 is disposed, and the supporting member 7, 7A is positioned in the neck part of the diaphragm 3.

Further, the thin speaker of the present invention is characterized in that the outer peripheral part of the edge 4 is supported by an outer peripheral part of the upper frame 5, and the outer peripheral part of the damper 9 is supported at an outer periphery of a hole 5d formed in the center part of the upper frame 5.

Further, the thin speaker of the present invention is characterized in being assembled by putting a magnetic circuit 2 on a central part of a first jig 1, mounting a short columnar supporting member 7 for supporting the magnetic circuit 2 to an upper part thereof, disposing a substantially cylindrical voice-coil-positioning second jig 12 around the supporting member 7, disposing a voice coil 6 through the second jig 12 at a right position in a magnetic gap of the inner-magnetic type magnetic circuit 2, mounting a neck part of a cone-shaped diaphragm 3 to an outer periphery of the voice coil 6, having an edge 4 at an outer peripheral part of the cone-shaped diaphragm 3 be supported by an outer peripheral part of an upper frame 5 which is put on or over a rear side of the diaphragm 3 and is formed with a hole 5d in a central part, assembling a damper 9 from a rear thereof, mounting an inner periphery thereof to the outer periphery of the voice coil 6 as well as having an outer peripheral part be supported by a part around the periphery of the hole 5d of the upper frame 5, pulling the second jig 12 out of the hole 5d, disposing the bottom frame 8 from the rear side thereof, and having the bottom frame 8 support the supporting member of the magnetic circuit 2.

Further, the thin speaker of the present invention is characterized in being assembled by putting a magnetic circuit 2 on a central part of a first jig 1, disposing a substantially cylindrical voice-coil-positioning second jig 12 around a short columnar supporting member 7A provided on an upper part of the magnetic circuit 2, disposing a voice coil 6 through the second jig 12 at a right position in a magnetic gap of the magnetic circuit 2, attaching a neck part of a cone-shaped diaphragm 3 to an outer periphery of the voice coil 6, having an edge 4 at an outer peripheral part of the cone-shaped diaphragm 3 be supported by an outer peripheral part of an upper frame which is put on or over the rear side of the diaphragm 3 and is formed with a hole 5d in a central part, assembling a damper 9 from the rear thereof, attaching an inner periphery thereof to the outer periphery of the voice coil 6 as well as having an outer peripheral part be supported by a part around the periphery of the hole 5d of the upper frame 5, pulling the second jig 12 out of the hole 5d, disposing the bottom frame 8 from the rear side thereof, and having the bottom frame 8 support the supporting member of the magnetic circuit 2.

### BRIEF DESCRIPTION OF DRAWINGS

FIG. 1 is a sectional view showing the internal structure of a thin speaker relating to a first embodiment of the present invention.

In FIG. 2, (a) shows a plan view of one half of an upper frame employed in the present invention, (b) shows a side view thereof, and (c) shows a bottom view of the half thereof.

In FIG. 3, (a) shows a plan view of one half of a bottom frame employed in the present invention, (b) shows a side view thereof, and (c) shows a bottom view of the half thereof.

FIG. 4 shows an explanatory view for the assembling process of the thin speaker relating to the first embodiment of the present invention.

FIG. 5 shows a section of the thin speaker of the present invention as assembled.

FIG. 6 shows a sectioned view showing the internal structure in a second embodiment of the present invention.

FIG. 7 shows a sectioned view showing a conventional thin speaker.

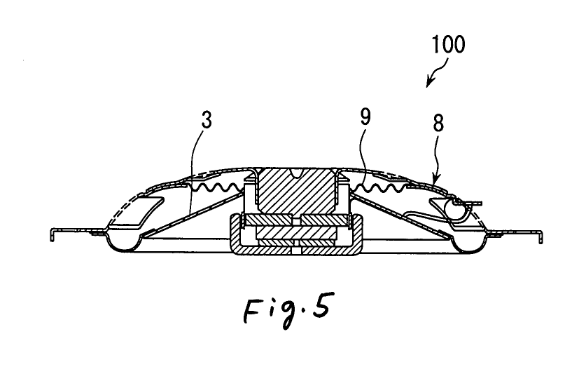

FIG. 8 shows a sectioned view showing another conventional thin speaker.

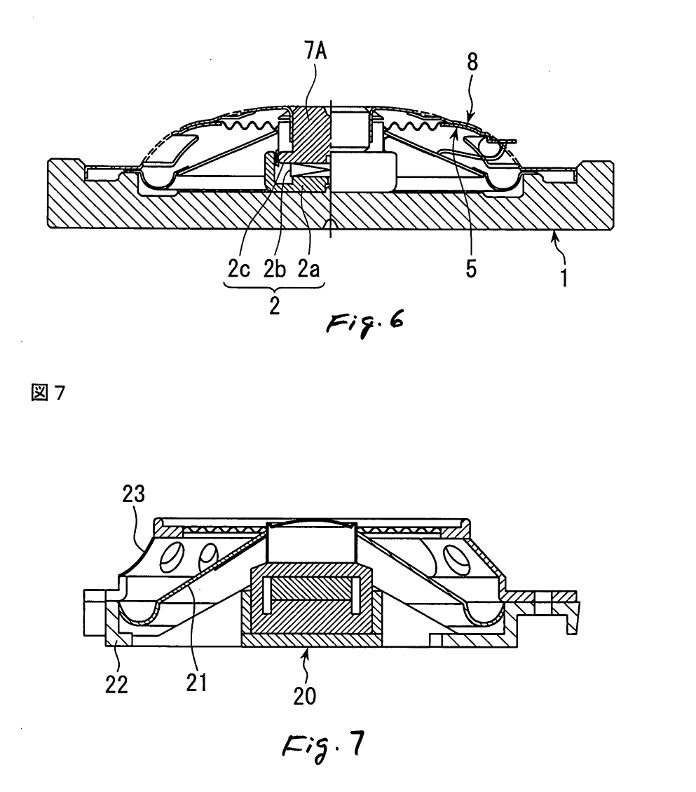

FIG. 9 shows a sectioned view showing still another conventional thin speaker.

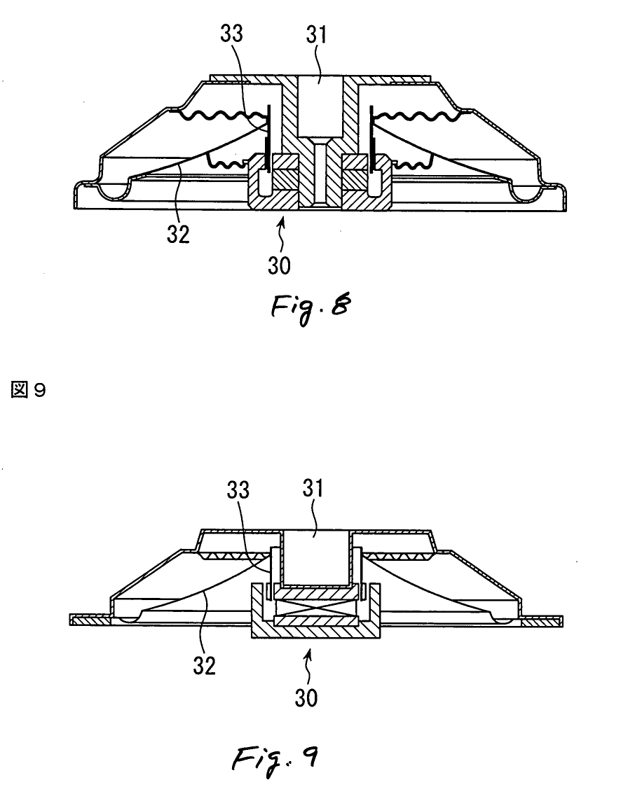

### THE BEST MODE FOR CARRYING OUT THE INVENTION

A thin speaker of the present invention is made to be of a structure where an upper frame 5 and a bottom frame 8 are disposed in front and rear and the frame is made to be of a firm dual structure in which the front upper frame 5 is made to support a vibration system, while the rear bottom frame 8 side is made to support an supporting member for a magnetic circuit 2, and the supporting member 7, 7A for the magnetic circuit 2 is positioned in the neck part of a diaphragm 3, so as not to obstruct the sound radiation.

Further, it is made possible to assemble each component by sequentially assembling them in one direction.

In the followings, the embodiments of the present invention are explained in detail with reference to the drawings.

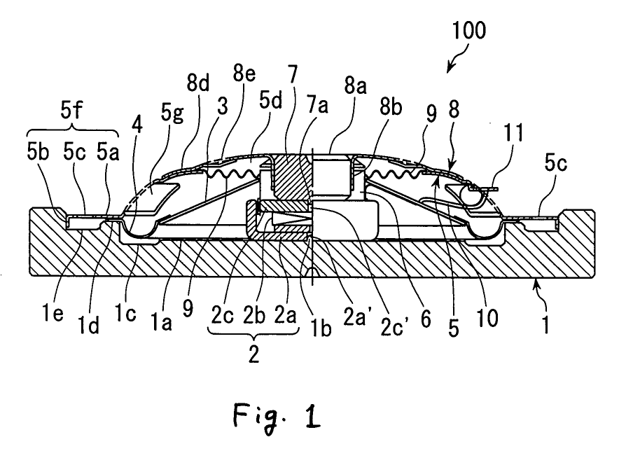

FIGS. 1 to 5 are a structural view of the thin speaker in a first embodiment of the present invention and explanatory views showing its assembling state.

First, an example of the arrangements of a thin speaker relating to a first embodiment of the present invention shall be explained with reference to FIGS. 1, 2(a)-(c) and 3(a)-(c).

FIG. 1 shows a speaker 100 assembled on and through a first jig 1 for the assembling. That is, the first jig 1 is formed in the inner surface thereof with a substantially circular flat part 1a, and in the central part of this flat part 1a there is formed a projection 1b for positioning and mounting an inner-magnetic type magnetic circuit 2. Further, a ring-shaped recess 1c is formed along the outer periphery of the substantially circular flat part 1a. This recess 1c is for housing an up-roll edge 4 which projects forward and one end of which is joined to the outer peripheral part of a diaphragm 3.

Along the outer periphery of the recess 1c there is formed an edge-part-supporting portion 1d formed to be a platform part formed as a projection. Along the outer periphery of this supporting portion 1d, there is formed a supporting part 1e for an edge-supporting-and-mounting portion 5a formed in a flange-shape along the outer periphery of a concave type upper frame 5. At the outer periphery of the edge supporting and mounting portion 5a of the upper frame 5 there is formed a bent part 5b formed as bent substantially into an L-shape, and this bent part 5b is abutted and fixed to the circumferential surface positioned at the outer side of the recess-like upper-frame-supporting part 1e. The edge supporting and mounting portion 5a is formed with a mounting hole 5c for mounting the speaker.

The magnetic circuit 2 to be placed on and fixed to the center part of the inner surface of the first jig 1 has a yoke 2a comprising a circular disk part and an outer peripheral wall formed along the outer periphery of the disk part, a short columnar magnet 2b provided on the inner surface of the yoke 2a, and a disk-shaped plate 2c provided on the upper part of the magnet 2b, wherein a magnetic gap is formed between the outer periphery of the plate 2c and the inner circumferential surface of the yoke 2a. Further, a positioning recess 2a′ corresponding to and engageable with the projection 1b of the first jig 1 is formed in the center of the outer surface of the yoke 2a.

The magnetic circuit 2 comprises an inner-magnet type magnetic circuit, in the magnetic gap of which one end part of a cylindrical voice coil 6 is positioned, while the neck part of the cone-shaped diaphragm 3 is coupled to the outer periphery of the upper part in the other end part of the voice coil 6. The outer periphery of this diaphragm 3 is mounted through the edge 4 to the edge supporting and mounting portion 5a of the upper frame 5.

A supporting member 7 comprising a short, substantially columnar adapter is placed and fixed onto the plate 2c of the magnetic circuit 2. A positioning projection 7a is formed in the center of the bottom part of this supporting member 7, and this projection 7a is engaged in a mounting hole 2c′ formed in the center part of the plate 2c to mount and fix the supporting member 7 onto the magnetic circuit 2.

In the present invention, the cone-shaped diaphragm 3 which is having the voice coil 6 and to which the edge 4 was mounted and so on are supported by the substantially dish-shaped upper frame 5 disposed on the outside thereof in the illustrated state.

This upper frame 5 formed substantially in the dish shape as a whole comprises, as shown in FIGS. 2(a)-(c) in detail, a main body 5e formed to have a circular hole 5d in the central part and to be curved, and a flange part 5f which is at the outer periphery of the main body 5e and extends outwardly in the substantially horizontal direction. The main body 5e is formed with a plurality of oblong sound holes 5g with intervals in the circumferential direction, the edge mounting and supporting portion 5a is formed in the peripheral part of the flange part 5f which has at least one mounting hole 5c, and further along the outer periphery thereof, there is formed the L-shaped bent part 5b for mounting and fixing it onto the first jig 1. This bent part 5b also functions as a reinforcement for the flange part 5f.

A bottom frame 8 to support the magnetic circuit 2 is disposed on the rear side of the upper frame 5, i.e., on the top part of its outside, and partly joined with the upper frame 5.

That is, in the present invention, the frame is made to be in a two-piece structure of the upper frame 5 to support the vibration system and the bottom frame 8 which has a diameter smaller than the upper frame 5, is disposed to be concentric with the upper frame 5 on the backside thereof such that one part overlaps with and is coupled to the upper frame 5, and which is to support the magnetic circuit 2.

As shown in FIGS. 3(a)-(c) in detail, this bottom frame 8 is formed with a circular hole 8a in the central part and is having a main body 8c substantially of a small dish shape and formed with a cylindrical part 8b projecting forwardly at the outer circumference of the hole 8a, and a flange part 8d extending outwardly at an angle to the front from the outer periphery of the main body 8c.

The main body 8c is formed with a plurality of window-like sound holes 8e which are formed as mutually spaced along the circumferential direction and elongated in the circumferential direction. And, the short columnar supporting member 7 integrated with and on the magnetic circuit 2 is inserted into and fixed to the cylindrical part 8b. That is, the magnetic circuit 2 is supported by the bottom frame 8, and the supporting member 7 for the inner-magnet type magnetic circuit 2 is made not to cover the front side of the sound radiating surface of the cone-shaped diaphragm 3 supported by the upper frame 5, so as not to give any bad influence on the acoustic characteristics.

In here, the outer peripheral part of the cone-shaped diaphragm 3 is mounted through the edge 4 to the flange-shaped edge supporting and mounting portion 5a of the upper frame 5, while the neck part on the inner circumferential side of the diaphragm 3 is coupled to the outer periphery of the voice coil 6 through an adhesive agent. To this outer periphery of the voice coil 6 an inner circumferential part of a damper 9 is coupled through an adhesive agent, while an outer peripheral part of this damper 9 is coupled through an adhesive agent to the part outside of the outer periphery of the hole 5d in the upper frame 5.

Other than those, in FIG. 1, reference numeral 10 denotes a lead wire, one end of which is connected, on the rear side of the cone-shaped diaphragm 3, to a terminal wire of the voice coil 6. Reference numeral 11 denotes a relay terminal which is of a shape of a cut and raised piece projecting from the back surface of the upper frame 5, and the other end of the lead wire 10 is connected thereto.

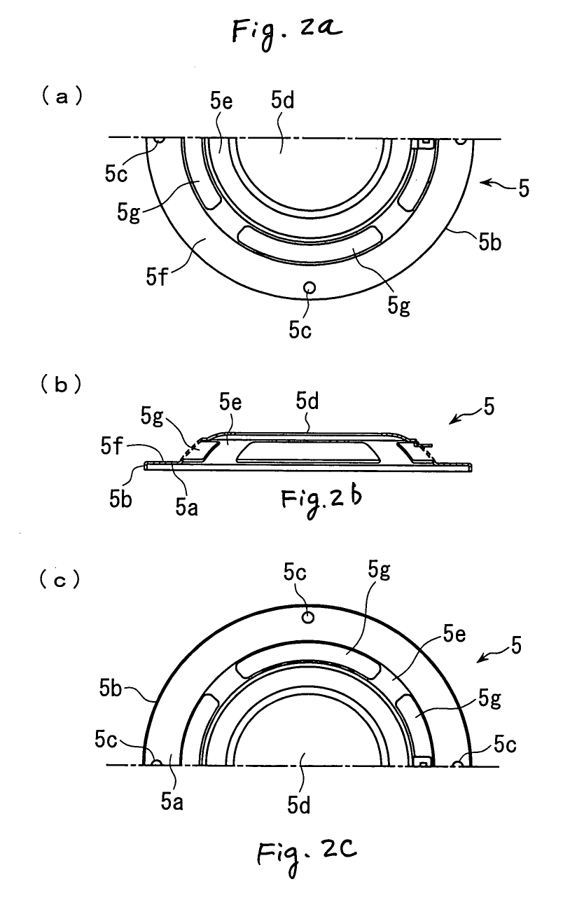

Next, an assembling method for the thin speaker of the first embodiment of the present invention shall be explained with reference to FIG. 4.

In the assembling, first, the separately pre-assembled magnetic circuit 2 is placed on the central part of the first jig 1 while the recess 2a′ in the outer surface of the yoke 2a is positioned to the projection 1b of the first jig 1, as being shown by an arrow.

Next, the supporting member 7 is integrated with the magnetic circuit 2 through an adhesive agent, while the projection 7a provided at the center of the front surface of the supporting member 7 is inserted into the hole 2c′ in the plate 2c of the magnetic circuit 2.

In assembling the voice coil 6, the substantially cylindrical second jig 12 is positioned on the outer periphery of the supporting member 7.

This second jig 12 is for positioning the voice coil 6, and after the second jig 12 is set at a predetermined position, the voice coil 6 is disposed on the outer periphery thereof. The second jig 12 functions as a gap gauge for controlling the inner circumference of the voice coil 6, and enables the assembling of high precision.

That is, the second jig 12 is made to have a smaller-diameter part 12a and, in the front thereof, a larger-diameter part 12b, where the outer diameter of the larger-diameter part 12b is made equal to the inner diameter of the voice coil 6 and a thickened part at the front end of the smaller-diameter part 12a is placed on the outer peripheral part of the plate 2c, so that the voice coil 6 can be disposed at a proper position in the magnetic gap.

After the disposition and retention of the voice coil 6, the neck part of the inner peripheral part in the cone-shaped diaphragm 3 provided with the edge 4 at the outer periphery is joined through an adhesive agent to a predetermined position on the outer peripheral part of the voice coil 6.

Further, the upper frame 5 is mounted. The outer periphery of the edge 4 is joined through an adhesive agent to the edge supporting and mounting portion 5a of the upper frame 5, and the upper frame 5 is placed on the first jig 1.

Next, the inner peripheral part of the damper 9 is joined through an adhesive agent to a predetermined position on the outer peripheral part of the voice coil 6, while the outer peripheral part of the damper 9 is mounted through the adhesive agent to the outer surface of the part outside of the periphery of the hole 5d in the upper frame 5.

As a result, the vibration system formed by the voice coil 6, damper 9, cone-shaped diaphragm 3 and so on is supported by the upper frame 5.

Thereafter, the bottom frame 8 is assembled and joined with the back side of the upper frame 5 for supporting the magnetic circuit 2, whereas the second jig 12 is pulled out through the hole 5d and removed before the bottom frame 8 is joined.

The adapter 7 is inserted into the cylindrical part 8b of the bottom frame 8, and is fixed by an adhesive agent. Also, the inner surface of the flange part 8d of the bottom frame 8 is put to overlap on the outer surface of the part around the periphery of the hole 5d in the upper frame 5, and joined and unified therewith by an adhesive agent.

After the assembling is finished and the adhesive agent at each part solidifies, the first jig 1 is removed to complete the thin speaker.

According to the present invention, the assembling can be carried out by sequentially assembling the each part in a single direction as explained above, and the assembling is made easier, able to be adapted to automation, and suitable for mass production.

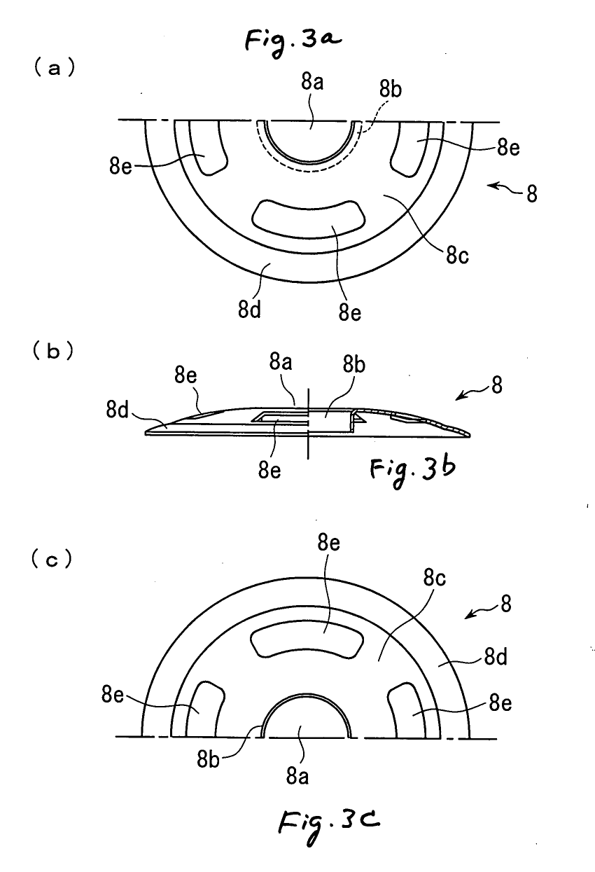

FIG. 5 shows a sectioned view of the assembled thin speaker 100.

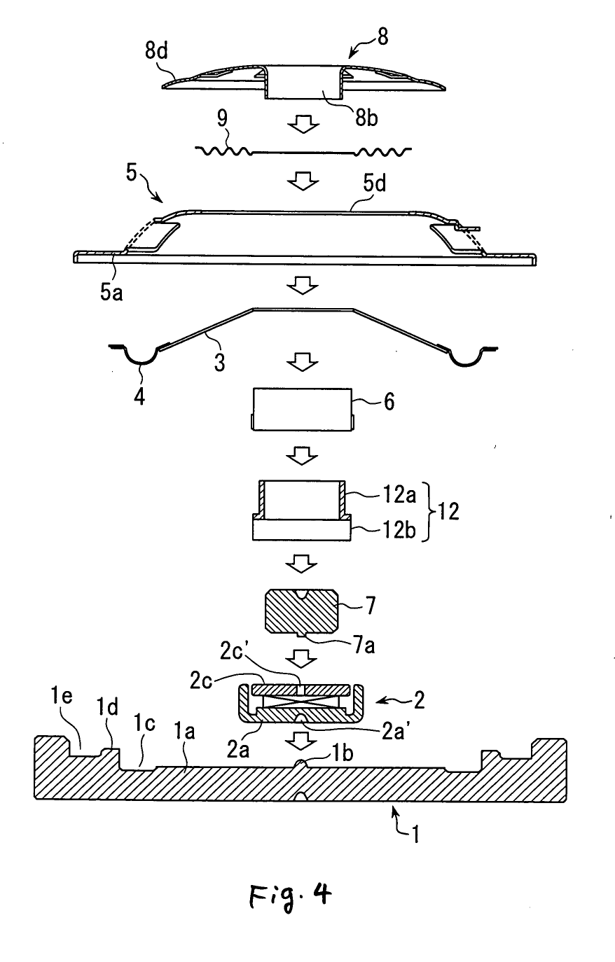

FIG. 6 is of a second embodiment of the present invention. This embodiment is characterized in that a short columnar supporting member 7A is formed integrally with the plate 2c of the inner-magnet type magnetic circuit 2, in an attempt to simplify the assembling.

That is, in the above-described first embodiment shown in FIG. 1 and so on, as the supporting member 7 is of a separate structure, an assembling step of the supporting member 7 is necessary in the assembling. However, in this second embodiment, because the supporting member 7A is integrally formed with the plate 2c, there is an advantage of being able to reduce its assembling step.

In here, as the other configuration is the same as in the first embodiment, and also the assembling process is substantially the same except for the absence of the assembling step for the supporting member, the explanation therefor shall be omitted.

By the way, the above embodiments are only for showing some examples, and various modifications can be performed without deviating from the gist of the present invention.

That is, the shape of the upper frame 5 and/or bottom frame 8 are not necessarily limited to a circular shape, and they can be, for example, of a polygonal shape. In that case, the first jig 1 can be prepared corresponding thereto. It is also possible to enlarge the shape of the bottom frame 8 to have its strength increased. Further, the edge 4 of the diaphragm 3 can be of down-roll, or, for example, of a mixture of up-rolls and down rolls. Still further, the present invention is of course applicable to an outer-magnet type magnetic circuit as the magnetic circuit 2.

### INDUSTRIAL APPLICABILITY

As has been described, according to the present invention, the frame is divided into two pieces, which are combined concentrically with a part of each frame overlapping with each other's, and one of the frames supports the cone-shaped diaphragm 3, while the other frame supports the supporting member for the magnetic circuit 2, which magnetic circuit 2 is disposed to be received in the neck part of the diaphragm 3, such that the supporting member for the magnetic circuit 2 will not come over the sound radiation plane of the diaphragm 3, whereby a thin speaker with a magnetic circuit disposed on the front side of a cone-shaped diaphragm can be established without causing the acoustic characteristics to be deteriorated, and the frame supporting the magnetic circuit of large weight is made to be two layer structure of partly overlapping relationship, so as to be further improved in the strength.

Further, according to the method for manufacturing the thin speaker of the present invention, the constituent parts can be assembled by sequentially stacking them up in the predetermined order on the single jig 1, whereby the assembling is made very easy, the mutual positional relationship between the respective parts can be set based on a single standard, and the ordinary gap gauge for controlling the inner circumference can be used for positioning the voice coil 6, which enables a highly precise assembling and prevents the occurrence of the troubles such as the rubbing of the voice coil.

1. A thin speaker, characterized in that a frame is made to be of a two-piece structure with an upper frame (5) and a bottom frame (8) disposed on the back side thereof concentrically and joined with their parts overlapping;
the upper frame (5) is supporting a vibration system including a cone-shaped diaphragm (3) having an edge (4) at an outer periphery, a voice coil (6) joined with a neck part of this diaphragm (3), a damper (9) supporting the voice coil (6) and so on;
a central part of the bottom frame (8) is supporting a supporting member (7, 7A) for a magnetic circuit (2) in a magnetic gap of which the voice coil (6) is disposed; and,
the supporting member (7, 7A) is positioned in the neck part of the diaphragm (3).

2. The thin speaker according to claim 1, characterized in that an outer peripheral part of the edge (4) is supported by an outer peripheral part of the upper frame (5), and an outer peripheral part of the damper (9) is supported by a part around a hole (5d) formed in a central part of the upper frame (5).

3. A method of manufacturing a thin speaker, characterized in an assembling comprising:
putting a magnetic circuit (2) on a central part of a first jig (1),
attaching a short columnar supporting member (7) for supporting the magnetic circuit (2) on an upper part thereof,
through a substantially cylindrical second jig (12) disposed around the member (7) for positioning a voice coil, disposing the voice coil (6) at a proper position in a magnetic gap of the magnetic circuit (2),
attaching a neck part of a cone-shaped diaphragm (3) to an outer periphery of the voice coil (6),
having an edge (4) at an outer peripheral part of the cone-shaped diaphragm (3) be supported by an outer peripheral part of an upper frame (5) formed to have a hole (5d) in a central part and to be put over a rear side of the diaphragm (3),
assembling a damper (9) from the rear side thereof, attaching its inner peripheral part to the outer periphery of the voice coil (6) and having an outer peripheral part be supported by a part around the hole (5d) of the upper frame (5),
pulling out the second jig (12) from the hole (5d),
putting a bottom frame (8) on from the rear side thereof, and
having the supporting member for the magnetic circuit (2) be supported by the bottom frame (8).

4. A method of manufacturing a thin speaker, characterized in an assembling comprising:
putting a magnetic circuit (2) on a central part of a first jig (1),
through a substantially cylindrical second jig (12) which is for positioning a voice coil and disposed around a short columnar supporting member (7A) provided on an upper part of the magnetic circuit (2), disposing the voice coil (6) at a proper position in a magnetic gap of the magnetic circuit (2),
attaching a neck part of a cone-shaped diaphragm (3) to an outer periphery of the voice coil (6),
having an edge (4) at an outer peripheral part of the cone-shaped diaphragm (3) be supported by an outer peripheral part of an upper frame (5) formed to have a hole (5d) in a central part and to be put over a rear side of the diaphragm (3),
assembling a damper (9) from the rear side thereof, attaching its inner peripheral part to the outer periphery of the voice coil (6) and having an outer peripheral part be supported by a part around the hole (5d) of the upper frame (5),
pulling out the second jig (12) from the hole (5d),
putting a bottom frame (8) on from the rear side thereof, and
having the supporting member of the magnetic circuit (2) be supported by the bottom frame (8).
